(19) United States
(12) Patent Application Publication
(10) Pub. No.: US 2008/0236312 A1
(43) Pub. Date: Oct. 2, 2008

(54) BEARING UNIT AND LINEAR UNIT EQUIPPED THEREWITH

(76) Inventors: Bernhard Keller, Wasserlosen (DE); Roland Hoherz, Kuetzberg (DE)

Correspondence Address: Striker, Striker & Stenby, 103 East Neck Road, Huntington, NY, 11743, US

(21) Appl. No.: 12/015,579

(22) Filed: Jan. 17, 2008

(30) Foreign Application Priority Data
Mar. 30, 2007 (DE) 20 2007 004 690.1

(51) Int. Cl. F16H 25/22; F16H 29/20

(52) U.S. Cl. 74/89.23; 384/44

(57) ABSTRACT

A bearing unit has a housing and a connecting element that is supported so that it is able to rotate around a rotation axis in the housing and is for producing a non-rotating connection between a drive shaft and a threaded spindle of a screw drive, in which at its end oriented toward the threaded spindle, the connecting element has a recess extending coaxial to the rotation axis for accommodating an end section of the threaded spindle, the end of the connecting element oriented toward the threaded spindle has at least one slot that is narrowable by a element; and a linear unit can be equipped with a bearing unit of this kind.

### CROSS-REFERENCE TO A RELATED APPLICATION

The invention described and claimed hereinbelow is also described in German Patent Application DE 20 2007 004 690.1 filed on Mar. 30, 2007. This German Patent Application, whose subject matter is incorporated here by reference, provides the basis for a claim of priority of invention under 35 U.S.C. 119(a)-(d).

### BACKGROUND OF THE INVENTION

The invention relates to a bearing unit including a housing and a connecting element, which is supported so that it is able to rotate around a rotation axis in the housing and is for producing a non-rotating connection between a drive shaft and a threaded spindle of a screw drive; the end of the connecting element oriented toward the threaded spindle has a recess extending coaxial to the rotation axis for accommodating an end section of the threaded spindle.

A bearing unit of this kind is known, for example, from DE 102 22 585 A1. In this bearing unit, the end of the threaded spindle is connected to the drive shaft by means of a separately embodied connecting sleeve.

In one embodiment, the connecting sleeve is attached to the threaded spindle by means of set screws that engage in threaded bores provided in the connecting sleeve and rest against the outer circumference surface of the threaded spindle. In this design, it is disadvantageous that the connecting sleeve and the threaded spindle, due to this type of fastening, are not situated completely coaxial to each other and consequently, the connection inevitably has a certain amount of imbalance.

In another embodiment, the threaded spindle is attached to the connecting sleeve by means of friction welding, which in comparison to a screw connection, is a very complicated type of connection.

Merely for the sake of completeness with respect to the prior art, reference is hereby also made to EP 0 552 488 B1, which has disclosed an expensive-to-manufacture adhesive connection between a connecting element and the end of a threaded spindle.

### SUMMARY OF THE INVENTION

By contrast, the object of the present invention is to disclose a bearing unit of the type mentioned at the beginning in which the connecting element can be easily connected to the threaded spindle without resulting in an imbalance that is relevant to actual use.

The object is attained according to the invention by means of a bearing unit of the type mentioned at the beginning in which the end of the connecting element oriented toward the threaded spindle has at least one slot that can be narrowed by means of clamping means.

When the at least one slot is narrowed, the connecting element rests coaxially against the outer circumference surface of the threaded spindle. This centered clamping of the threaded spindle effectively counteracts the production of an imbalance. It is also advantageous that the end of the threaded spindle does not require machining for this clamping, which significantly simplifies production.

If the clamping means include at least one clamping screw that engages in a clamping passage that is embodied in a shoulder that is of one piece with the connecting element, then the clamping procedure can therefore be executed in a particularly simple fashion. The clamping screw in this case can be inserted into a thread-free passage on the one side of the slot, bridge across the slot, and engage in a thread provided on the other side of the slot; the screw rests with its head against the thread-free side during clamping.

In order to effectively counteract the production of an imbalance, according to a modification of the invention, the end of the connecting element oriented toward the threaded spindle has at least a pair of slots situated diametrically opposite each other in relation to the rotation axis. Depending on the design speed of the threaded spindle, the two clamping screws associated with the at least one pair of slots can be oriented in the same direction as each other or in opposite directions from each other.

The arrangement of the two clamping screws orientated in opposite directions here has the advantage, due to the arrangement of these clamping screws point-symmetrical to the rotation axis in a section taken orthogonal to the rotation axis, of being largely free of imbalance, which is particularly advantageous at high speeds. The arrangement with the screws oriented in the same direction, which is particularly suitable for low speeds, has the advantage over this of a simpler and more reasonably priced production since the required threaded bores can be accommodated in one and the same clamping element in the connecting element.

On its side destined for connection with the drive shaft, the connecting element can be embodied in different ways. Thus, for use with a conventional coupling, for example, it can have a connecting pin at its end oriented toward the drive shaft.

In order to permit the elimination of such a conventional coupling, however, at its end oriented toward the drive shaft, the connecting element can also have a recess extending coaxial to the rotation axis, into which an end section of the drive shaft can be inserted. In this case, the end of the connecting element oriented toward the drive shaft can have at least one slot that can be narrowed by means of clamping means, preferably at least a pair of slots situated diametrically opposite each other in relation to the rotation axis.

Particularly when the housing of the bearing unit is embodied of one piece, it can be advantageous if the clamping means include a cleft or split clamping ring. In this case, the connecting element can be inserted in a specifically simple fashion through the one-piece housing and be equipped with the clamping ring at the other end.

The recess at the end oriented toward the threaded spindle and the recess at the end oriented toward the drive shaft can transition into each other so that the connecting element is embodied as sleeve-shaped or tubular. In principle, it is also conceivable for the above-mentioned pin to be embodied in the form of a hollow pin so that this, too, can be considered to be a sleeve-shape or tubular embodiment of the connecting element. Furthermore, the resulting axial passage does not need to expand in a smooth-walled fashion over the entire length of the connecting element, but can also be embodied as having one or more steps.

According to a modification of the invention, the bearing unit is embodied as a fixed bearing unit, i.e. the connecting element is supported in the housing in an axially fixed fashion in the direction of the rotation axis. For example, if the clamping means at the end oriented toward the threaded spindle includes a shoulder that is of one piece with the connecting element and a clamping ring at the end oriented toward the drive shaft, then the axially fixed bearing is secured through cooperation of contact surfaces provided on this shoulder and clamping ring with corresponding counterpart contact surfaces provided on the housing of the bearing unit.

In order to provide the rotary support of the connecting element, its outer circumference can be provided with at least one roller bearing that can be embodied, for example, in the form of an angular contact ball bearing. This at least one roller bearing can be inserted into a stepped passage through the housing; the at least one outer ring of the at least one roller bearing rests against the step of the passage at one end and at the other end, is held in the passage of the housing by means of a threaded ring. In analogous fashion, the at least one inner ring of the at least one roller bearing can rest against a step of the connecting element at one end and at the other end, can likewise be held by means of a threaded ring. When a clamping ring is used, it is possible to eliminate a separate threaded ring; in this case, the clamping ring also performs the function of the threaded ring.

If the inner raceway of the at least one roller bearing is embodied on the outer circumference of the connecting element, then not only does this make it possible to reduce the structural height of the bearing unit according to the invention, but also makes it possible to eliminate a separate threaded ring, regardless of whether a clamping ring is used.

According to a modification of the invention, the housing can be fastened to a larger structural unit. This larger structural unit can, for example, be a mounting plate to which is attached the bearing unit and possibly also the entire linear unit to which the bearing unit belongs. Alternatively, however, it is also possible for the housing to be mountable to a main body of a linear module. In both cases, it is advantageous if the housing can also be fastened to a drive unit to which the drive shaft belongs.

According to another aspect, the invention also relates to a linear unit having a drive unit with a drive shaft that can rotate around a rotation axis, a threaded spindle of a screw drive, and a bearing unit according to the invention embodied in the manner explained above, in particular with a connecting element for producing a non-rotating connection between the drive shaft and the threaded spindle.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a linear unit equipped with a bearing unit according to the invention;

FIG. 2 is an exploded view of a first embodiment of a bearing unit according to the invention;

FIG. 3 is a perspective sectional view of the bearing unit shown in FIG. 2;

FIG. 4 is a perspective view of a first embodiment of a connecting element;

FIG. 5 is a perspective view of a second embodiment of a connecting element;

FIG. 6 is an exploded view of a second embodiment of a bearing unit according to the invention;

FIG. 7 is a perspective sectional view of the bearing unit shown in FIG. 6; and

FIG. 8 is a perspective sectional view of a third embodiment of a bearing unit according to the invention.

### DESCRIPTION OF THE PREFERRED EMBODIMENTS

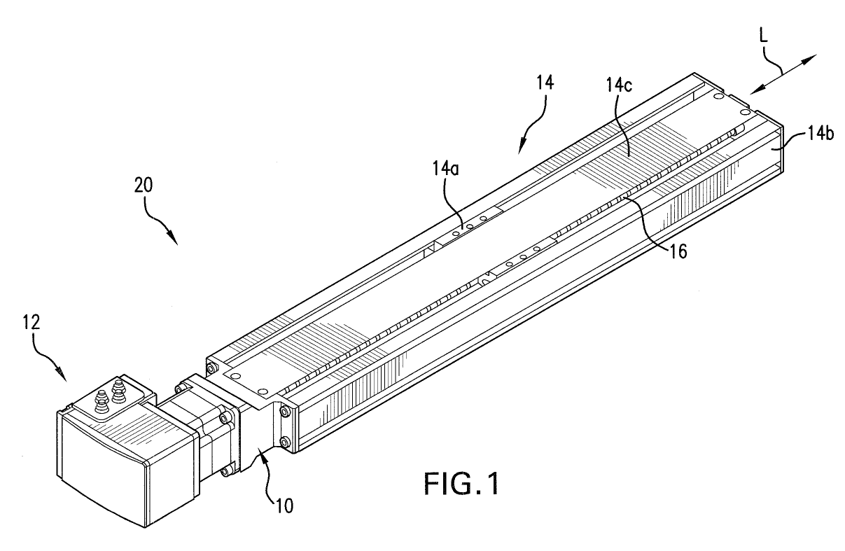

In FIG. 1, a bearing unit according to the invention is labeled as a whole with the reference numeral 10. More precisely stated, the bearing unit 10 is shown as part of a linear module 20, which also includes a drive unit 12 and a main module unit 14.

In the exemplary embodiment shown, the main module unit 14 is embodied with an intrinsically known spindle drive. It is therefore unnecessary to explain the spindle drive in greater detail at this point. Mention is merely made of the fact that it includes a runner block 14a that is supported so that it is able to slide in the longitudinal direction L in a housing part 14b. The threaded spindle 16 of the spindle drive, which engages with the threads of a threaded nut (not shown) connected to the runner block 14a—in particular the roller element nut of the spindle drive, is partially covered in FIG. 1 by a cover plate 14c that belongs to the housing part 14b.

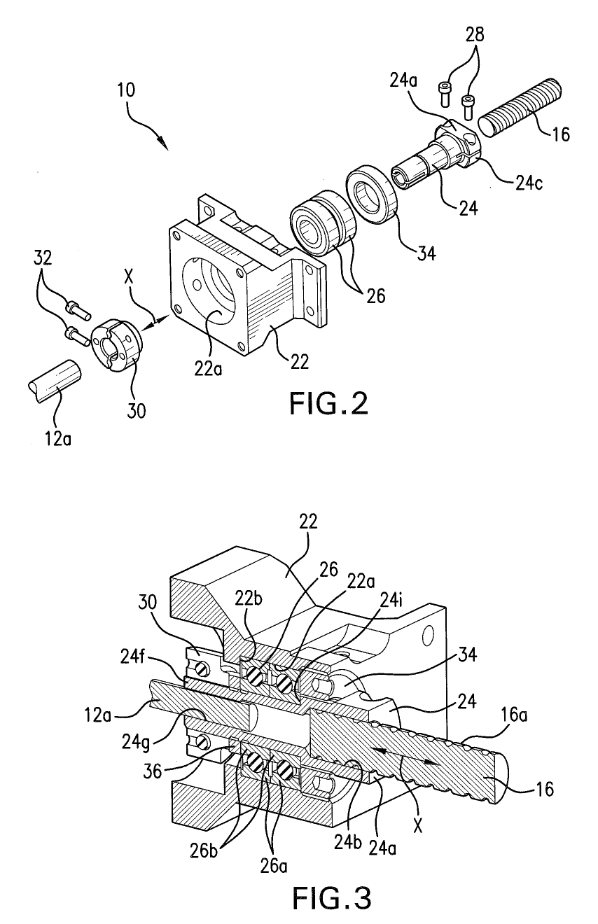

FIGS. 2 and 3 show the bearing unit 10 according to the invention in an exploded depiction and in a sectional perspective depiction. The bearing unit includes a housing 22, which, as shown in FIG. 1, is connected to the main body 14b at one end and is connected to the drive unit 12, in particular screwed to it, at the other end. In addition, the bearing unit 10 has a connecting element 24, which is supported so that it can rotate around the rotation axis X in the housing 22 by means of two roller bearings 26, for example two angular contact ball bearings. The connecting element 24 serves to connect the threaded spindle 16 of the screw drive to the drive shaft 12a of the drive unit 12.

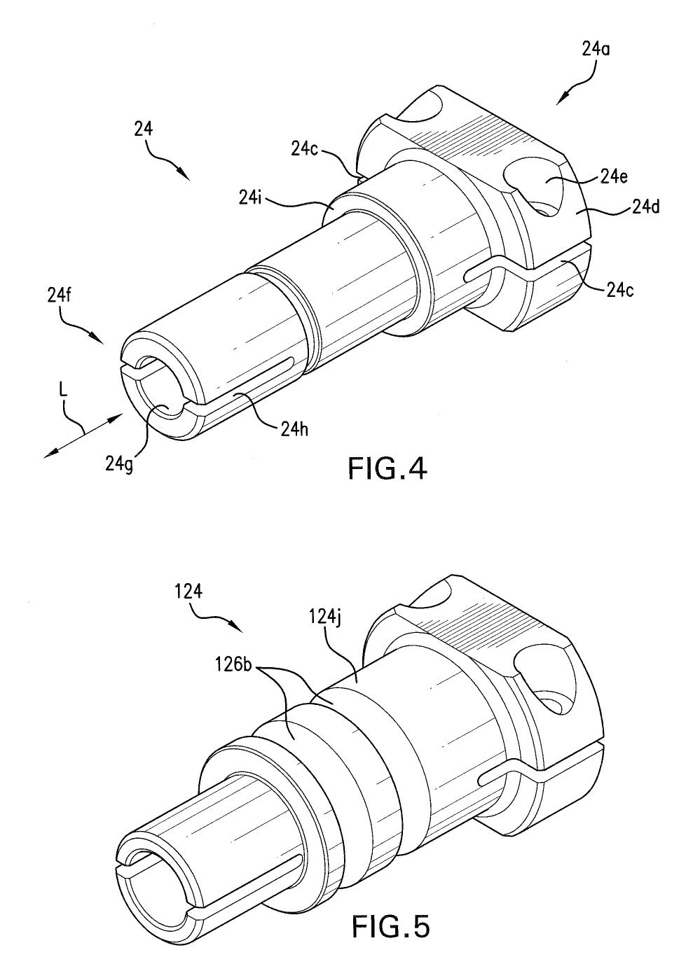

At its end 24a oriented toward the threaded spindle 16, the connecting element 24 is provided with a recess 24b that serves to accommodate the threaded spindle 16. As is also shown in FIG. 4, two slots 24c are let into the connecting element 24 from this end 24a, which pass all the way through the connecting element 24 in the radial direction and extend a predetermined distance in the direction of the rotation axis X. In the region of the axially open end of each of these slots 24c, the connecting element 24 is provided with a radial shoulder 24d that is integrally formed onto it, in which a clamping passage 24e for a clamping screw 28 is provided. With the aid of the clamping screws 28, the slots 24c can be narrowed so that the recess 24b is placed coaxially against the outer circumference surface 16a of the threaded spindle 16 in the circumference direction in relation to the rotation axis X, thus securing this threaded spindle.

In an analogous fashion, the end 24f of the connecting element 24 oriented toward the drive shaft 12a also has a recess 24g for accommodating the drive shaft 12a. In addition, slots 24h are let into the connecting element 24 from its end 24f oriented toward the drive shaft 12a; in cooperation with a clamping ring 30 and its clamping means 32, these slots serve to fastened the connecting element 24 to the drive shaft 12a.

The fact that a separate clamping ring 30 is provided at the end 24f oriented toward the drive shaft 12a and is not provided with an integrally embodied clamping shoulder 24d like the one at the end 24a oriented toward the threaded spindle 16 is merely due to the fact that the housing 22 of the bearing unit 10 in the exemplary embodiment shown it is of a one-piece design. If the housing 22 were to be composed of two different bearing shells that could be fastened to each other, then an integrally embodied clamping shoulder could also be provided at the end 24f oriented toward the drive shaft 12a. Independent of the above-discussed variants for the embodiment of the housing, it is naturally also possible to replace the clamping shoulder 24d with a separate clamping ring even if this is not required for technical production reasons.

As is shown in FIG. 3, the central passage 22a through the housing 22 is embodied with a step 22b against which the outer rings 26a of the roller bearings 26 rest in the axial direction. A threaded ring 34 that is screwed into the passage 22a serves to secure the roller bearings 26 in the passage 22a of the housing 22. In analogous fashion, the inner rings 26b of the roller bearings 26 rest in the axial direction against a step 24i of the connecting element 24 and are secured in the passage 22a of the housing 22 by means of a threaded ring 36 that is screwed onto the connecting element 24. In this fashion, the bearing unit 10 is embodied in the form of a fixed bearing unit, i.e. as a bearing unit that does not permit any movement of the threaded spindle in the axial direction.

According to a preferred embodiment, the threaded ring 36 and the clamping ring 30 are integrally joined to each other.

FIG. 5 shows a modified embodiment of a connecting element of the kind that can be used in a bearing unit according to the invention. The connecting element according to FIG. 5 corresponds essentially to the connecting element 24 according to FIG. 4. Consequently, all the parts in FIG. 5 have been provided with the same reference numerals as in FIG. 4, but increased by the number 100. In addition, the connecting element 124 according to FIG. 5 will only be described insofar as it differs from the connecting element 24 according to FIG. 4; for the remainder of its description, express reference is hereby made to this prior description.

The connecting element 124 according to FIG. 5 differs from the connecting element 24 according to FIG. 4 merely in that it also performs the function of the inner rings 26b of the roller bearings 26. To this end, two raceways 126b for the roller elements of the roller bearings are embodied on its outer circumference surface 124j. Not only does this have the technical production advantage that the bearing unit 10 according to the invention is composed of a smaller number of parts, it also offers the additional advantage that it is smaller and therefore requires a smaller amount of space to be provided for it.

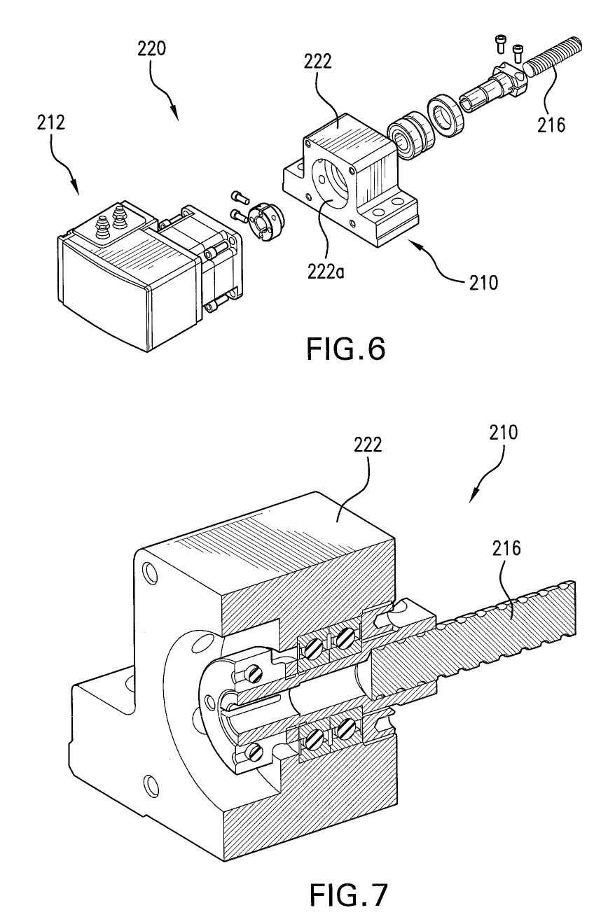

The exemplary embodiment according to FIGS. 6 and 7 should illustrate that bearing units according to the invention can be used not only in the linear module 20 shown in FIG. 1, but can also be used in a conventional linear unit 220. The embodiment according to FIG. 6 will therefore be described only insofar as it differs from the embodiment shown in FIGS. 1 through 4 and the variant thereof shown in FIG. 5; for the remainder of its description, express reference is hereby made to these prior descriptions.

The linear unit 220 according to FIGS. 6 and 7 has a drive unit 212 that serves to drive an open threaded spindle 216. In particular, therefore, no housing part is provided that corresponds to the main body 14b. Consequently, the housing 222 of the bearing unit 210 is also not embodied for attachment to such a main body, but instead for attachment to a mounting plate (not shown). The internal embodiment of the housing 222, in particular with regard to its passage 222a, however, is identical to that of the housing 22. Since this can be easily inferred in particular through a comparison of FIG. 7 to FIG. 3, the internal embodiment of the housing 222 does not need to be described in further detail at this point.

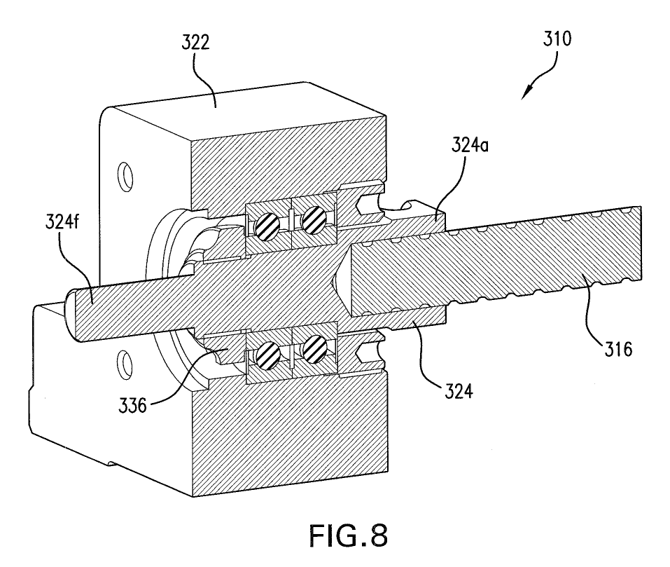

FIG. 8 shows another embodiment variant. The bearing unit according to FIG. 8 corresponds essentially to the bearing unit 210 according to FIGS. 6 and 7. Consequently, in FIG. 8, analogous parts have been provided with the same reference numerals as in FIGS. 6 and 7, but increased by the number 100. For this reason, the bearing unit 310 according to FIG. 8 will only be described below insofar as it differs from the bearing unit 210 according to FIGS. 6 and 7; for the remainder of its description, express reference is hereby made to the prior descriptions of FIGS. 1 through 5.

The bearing unit 310 according to FIG. 8 differs from the bearing unit 210 according to FIGS. 6 and 7 only with respect to the embodiment of the connecting element 324, more precisely stated with regard to the embodiment of its end 324f oriented toward the drive shaft. By contrast with the slotted embodiment of the previously described embodiments, the end 324f of the connecting element 324 oriented toward the drive shaft is embodied in the form of a simple pin 324f, which can be connected to the drive shaft of the drive unit by means of a simple coupling element. In this case, it is therefore unnecessary to provide any clamping ring corresponding to the clamping ring 30, but instead, requires only the provision of a threaded ring 336. The end 324a of the connecting element 324 oriented toward the threaded spindle 316, however, is embodied as slotted, as has already been disclosed in the embodiments described above.

Even if the housing 324 of the embodiment according to FIG. 8 is embodied for attachment to a mounting plate (not shown), the same connecting element 324 can naturally also be used in the linear module 20 according to FIG. 1 in which the housing 22 of the bearing unit 10 is not embodied for attachment to the mounting plate, but instead for attachment to the main body 14b of the module unit 14.

It will be understood that each of the elements described above, or two or more together, may also find a useful application in other types of constructions differing from the type described above.

While the invention has been illustrated and described as embodied in a bearing unit and linear unit equipped therewith, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A bearing unit, comprising a housing; a connecting element supported so that it is rotatable around a rotation axis in said housing and produces a non-rotating connection between a drive shaft and a threaded spindle of a screw drive, said connecting element at its end orientable toward the threaded spindle having a recess extending coaxial to said rotation axis for accommodating an end section of the threaded spindle, said end of said connecting element oriented toward the threaded spindle having at least one slot that is narrowable; and clamping means which narrow said at least one slot.

2. A bearing unit as defined in claim 1, wherein said clamping means include at least one clamping screw that engages a clamping passage provided in a shoulder that is of one piece with said connecting element.

3. A bearing unit as defined in claim 1, wherein said end of said connecting element orientable toward the threaded spindle have at least a pair of slots situated diametrically opposite to each other in relation to said rotation axis.

4. A bearing unit as defined in claim 1, wherein said connecting element has an end orientable toward the drive shaft and is provided at said end with a connecting pin.

5. A bearing unit as defined in claim 1, wherein said connecting element has an end orientable toward the drive shaft and is provided at said end with a recess extending coaxial to said rotation axis for accommodating an end section of the drive shaft.

6. A bearing unit as defined in claim 5, wherein said end of said connecting element orientable toward the drive shaft has at least one slot that is narrowable; and further comprising clamping means for narrowing said at least one slot of said end of said connecting element orientable toward the drive shaft.

7. A bearing unit as defined in claim 6, wherein said clamping means have a clamping ring selected from the group consisting of a cleft clamping ring and a split clamping ring.

8. A bearing unit as defined in claim 1, wherein said connecting element is an element selected from the group consisting of a sleeve-shaped connecting element and a tubular element.

9. A bearing unit as defined in claim 1, wherein said connecting element is supported in said housing in an axially fixed fashion in a direction of said rotation axis.

10. A bearing unit as defined in claim 1; and further comprising at least one roller bearing provided on an outer circumference of said connecting element.

11. A bearing unit as defined in claim 10, wherein said at least one roller bearing has an inner raceway embodied on the outer circumference of said connecting element.

12. A bearing unit as defined in claim 1, wherein said housing is attachable to a larger structural unit.

13. A bearing unit as defined in claim 1, wherein said housing is attachable to a main body of a linear module.

14. A bearing unit as defined in claim 1, wherein said housing is attachable to a drive unit of which the drive shaft is a component.

15. A linear unit, comprising a drive unit with a drive shaft which is rotatable around a rotation axis; a threaded spindle of a screw drive; and a bearing unit including a housing, a connecting element supported so that it is rotatable around a rotation axis in said housing and produces a non-rotating connection between said drive shaft and said threaded spindle of said screw drive, said connecting element at its end orientable toward said threaded spindle having a recess extending coaxial to said rotation axis for accommodating an end section of said threaded spindle, said end of said connecting element oriented toward said threaded spindle having at least one slot that is narrowable; and clamping means which narrow said at least one slot.

16. A linear unit as defined in claim 15, wherein said screw drive is configured as a ball screw drive.
